(19) United States
(12) Patent Application Publication
(10) Pub. No.: US 2022/0294357 A1
(43) Pub. Date: Sep. 15, 2022

(54) STACKED CAPACITIVE COUPLED RESONANT DUAL ACTIVE BRIDGE DC-DC CONVERTER

(71) Applicant: Carrier Corporation, Palm Beach Gardens, FL (US)

(72) Inventors: Parikshith B. Channegowda, Glastonbury, CT (US); Luis Arnedo, South Glastonbury, CT (US); Yongduk Lee, Vernon, CT (US); Weilun Chen, Vernon, CT (US)

(21) Appl. No.: 17/639,694

(22) PCT Filed: Oct. 27, 2020
(86) PCT No.: PCT/US2020/057451

§ 371 Date: Mar. 2, 2022

Related U.S. Application Data
(60) Provisional application No. 62/927,869, filed on Oct. 30, 2019.

(51) Int. Cl. H02M 3/335; H02M 3/00

(52) U.S. Cl. CPC H02M 3/33573; H02M 3/01

(57) ABSTRACT

Systems for stacked capacitive coupled resonant dual active bridge DC-DC converters are provided. Aspects include a first phase circuit topology comprising a power source and a power inverter circuit, a plurality of LC circuits comprising a first LC circuit and a second LC circuit, and a second phase circuit topology comprising a plurality of AC-DC converter circuits comprising a first AC-DC converter circuit and a second AC-DC converter circuit, wherein the first AC-DC converter circuit is in a parallel configuration with the second AC- DC converter circuit, wherein the first LC circuit couples the first phase circuit topology to the first AC-DC converter and wherein the second LC circuit couples the first phase circuit topology to the second AC-DC converter.

### CROSS REFERENCE TO RELATED APPLICATIONS

This application claims the benefit of U.S. Application No. 62/927,869, tiled on Oct. 30, 2019, which is incorporated herein by reference in its entirety.

### BACKGROUND

The present invention generally relates to DC-DC converters, and more specifically, to stacked capacitive coupled resonant dual active bridge DC-DC converters.

Traditional refrigerated cargo trucks or refrigerated tractor trailers, such as those utilized to transport cargo via sea, rail, or road, is a truck, trailer or cargo container, generally defining a cargo compartment, and modified to include a refrigeration system located at one end of the truck, trailer, or cargo container. Refrigeration systems typically include a compressor, a condenser, an expansion valve, and an evaporator serially connected by refrigerant lines in a closed refrigerant circuit in accord with known refrigerant vapor compression cycles. A power unit, such as a combustion engine, drives the compressor of the refrigeration unit, and may be diesel powered, natural gas powered, or other type of engine. In many tractor trailer transport refrigeration systems, the compressor is driven by the engine shaft either through a belt drive or by a mechanical shaft-to-shaft link. In other systems, the engine of the refrigeration unit drives a generator that generates electrical power, which in-turn drives the compressor.

With current environmental trends, improvements in transportation refrigeration units are desirable particularly toward aspects of efficiency, sound and environmental impact. With environmentally friendly refrigeration units, improvements in reliability, cost, and weight reduction is also desirable.

### SUMMARY

Embodiments of the present invention are directed to system. A non-limiting example of the system includes a first phase circuit topology comprising a power source and a power inverter circuit, a plurality of LC circuits comprising a first LC circuit and a second LC circuit, and a second phase circuit topology comprising a plurality of AC-DC converter circuits comprising a first AC-DC converter circuit and a second AC-DC converter circuit, wherein the first AC-DC converter circuit is in a parallel configuration with the second AC-DC converter circuit, wherein the first LC circuit couples the first phase circuit topology to the first AC-DC converter and wherein the second LC circuit couples the first phase circuit topology to the second AC-DC converter.

Embodiments of the present invention are directed to system. A non-limiting example of the system includes a first phase circuit topology comprising a power source and a power inverter circuit, a plurality of LC circuits comprising a first LC circuit and a second LC circuit, a plurality of switches comprising a first switch and a second switch, and a second. phase circuit topology comprising a plurality of AC-DC converter circuits comprising a first AC-DC converter circuit and a second AC-DC converter circuit, wherein the first AC-DC converter circuit is in a parallel configuration with the second AC-DC converter circuit, wherein the first switch couples the first phase circuit topology to the first LC circuit, wherein the first LC circuit couples the first switch to the first AC-DC converter, wherein the second switch couples the first phase circuit topology to the second LC circuit, wherein the second LC circuit couples the second switch to the second AC-DC converter, and a controller configured to operate the first switch to control the first AC-DC converter circuit and operate the second switch to control the second AC-DC converter circuit.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

FIG. 1 depicts a transport refrigeration system according to one or more embodiments;

FIG. 2 depicts a block diagram of a circuit topology for a stacked capacitive coupled resonant dual active bridge DC-DC converter according to one or more embodiments; and

FIG. 3 depicts a simplified circuit topology 300 for a stacked capacitive resonant dual active bridge DC-DC converter according to one or more embodiments.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, dual active bridge (DAB) is a bidirectional DC-DC converter topology that is typically suitable for high power and high efficiency. This topology is utilized for interfacing battery and photovoltaic energy sources to a shared DC bus. However, a disadvantage of the DAB topology includes the need for a high frequency transformer between the input and output stage of the circuit which adds weight, reduces power density, restricts switching frequency, and adds design complexity.

Aspects of the present disclosure address the disadvantages of the above-described DAB topology by providing capacitive coupling between the input stage and output stage in lieu of the high frequency transformer. This capacitive coupling increases power density and eliminates magnetic losses which maintaining desirable characteristics of a DAB converter. This DAB topology can be utilized in a variety of applications including, but not limited, to transport refrigeration systems in hybrid electric vehicles to provide a boosted voltage from one or more batteries and/or photovoltaic power supplies to a transport refrigeration system.

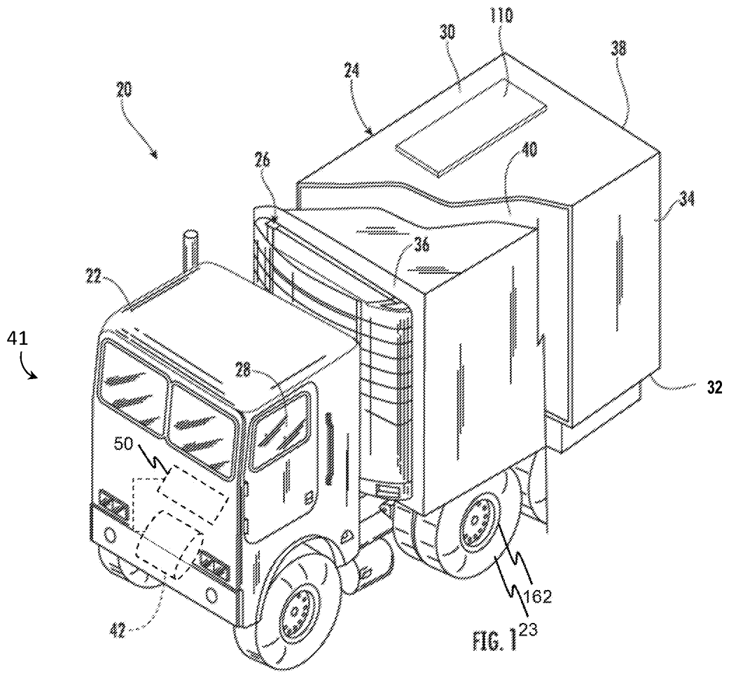

Referring to FIG. 1, a transport refrigeration system 20 of the present disclosure is illustrated. In the illustrated embodiment, the transport refrigeration systems 20 may include a tractor or vehicle 22, a container 24, and an engineless transportation refrigeration unit (TRU) 26. The container 24 may be pulled by a vehicle 22. It is understood that embodiments described herein may be applied to shipping containers that are shipped by rail, sea, air, or any other suitable container, thus the vehicle may be a truck, train, boat, airplane, helicopter, etc. The vehicle 22 may be fitted or include a generator 162 to harvest electrical power from kinetic energy of the vehicle 22. The generator 162 can be at least one of an axle generator and a hub generator mounted configured to recover rotational energy when the transport refrigeration system 20 is in motion and convert that rotational energy to electrical energy, such as, for example, when the axle of the vehicle 22 is rotating due to acceleration, cruising, or braking. The axle generator may be mounted on a wheel axle (not shown) of the vehicle 22 and the hub generator may be mounted on a wheel 23 of the vehicle 22. It is understood that the generator 162 may be mounted on any wheel or axle of the vehicle 22 and the mounting location of the generator 162 illustrated in FIG. 1 is one example of a mounting location.

The vehicle 22 may include an operator's compartment or cab 28 and a propulsion motor 42 which is part of the powertrain or drive system of the vehicle 22. The vehicle 22 may be driven by a driver located within the cab, driven by a driver remotely, driven autonomously, driven semi-autonomously, or any combination thereof. The propulsion motor 42 may be an electric motor or a hybrid motor (e.g., a combustion engine and an electric motor). The propulsion motor 42 may also be part of the power train or drive system 22 of the trailer system (i.e., container 24). thus the propulsion motor configured to propel the wheels of the vehicle 22 and/or the wheels of the container 24. The propulsion motor 42 may be mechanically connected to the wheels of the vehicle 22 and/or the wheels of the container 24. A vehicle energy storage device 50 is electrically connected to the propulsion motor 42 as part of a vehicle electrical power train 41. It is understood that the vehicle electrical powertrain 41 is illustrated as only comprising a propulsion motor 42 and vehicle storage device 50 for simplification, the vehicle electrical powertrain 41 may have additional components not illustrated in FIG. 1. The vehicle energy storage device 50 is configured to provide electricity to power the propulsion motor 42.

The container 24 may be coupled to the vehicle 22 and is thus pulled or propelled to desired destinations. The container 24 may include a top wall 30, a bottom wall 32 opposed to and spaced from the top wall 30, two side walls 34 spaced from and opposed. to one-another, and opposing front and rear walls 36, 38 with the front wall 36 being closest to the vehicle 22. The container 24 may further include doors (not shown) at the rear wall 38, or any other wall. The walls 30, 32, 34, 36, 38 together define the boundaries of a. refrigerated cargo space 40. Typically, transport refrigeration systems 20 are used to transport and distribute cargo, such as, for example perishable goods and environmentally sensitive goods (herein referred to as perishable goods). The perishable goods may include but are not limited to fruits, vegetables, grains, beans, nuts, eggs, dairy, seed, flowers, meat, poultry, fish, ice, blood, pharmaceuticals, or any other suitable cargo requiring cold chain transport. In the illustrated embodiment, the TRU 26 is associated with a container 24 to provide desired environmental parameters, such as, for example temperature, pressure, humidity, carbon dioxide, ethylene, ozone, light exposure, vibration exposure, and other conditions to the refrigerated cargo space 40. In further embodiments, the TRU 26 is a refrigeration system capable of providing a desired temperature and humidity range.

Referring to FIG. 1, the container 24 is generally constructed to store a cargo (not shown) in the refrigerated cargo space 40. The engineless TRU 26 is generally integrated into the container 24 and may be mounted to the front wall 36. The cargo is maintained at a desired temperature by cooling of the refrigerated cargo space 40 via the TRU 26 that circulates refrigerated airflow into and through the refrigerated cargo space 40 of the container 24. It is further contemplated and understood that the TRU 26 may be applied to any transport compartments (e.g., shipping or transport containers) and not necessarily those used in tractor trailer systems. Furthermore, the transport container may be a part of the of the vehicle 22 or constructed to be removed from a framework and wheels (not shown) of the container 24 for alternative shipping means marine, railroad, flight, and others).

In one or more embodiments, the TRU 26 includes a refrigeration system that is utilized to sustain an appropriate temperature based on the cargo being stored in the TRU. This refrigeration system is connected to a shared direct-current (DC) bus that allows the refrigeration system to draw power to operate within the TRU 26. The DC bus is typically connected to a power source which can include one or more batteries and/or photovoltaic power sources. The refrigeration systems typically require a higher voltage requirement than what is typically supplied by the battery power source. To address this, DC-DC converters are utilized to provide a required voltage level to the refrigeration system, among other systems, on the TRU 26.

In one or more embodiments, a series resonant capacitive coupling is introduced between input and output stages of a DC-DC dual active bridge converter. The DC-DC dual active bridge converter can be utilized to boost a voltage in a TRU, for example. The converter is operated such that the switching frequency is fixed close to the resonant frequency of the coupling network and the power flow is modulated using both linear phase shift control of AC voltage waveform. The power flow can also be modulated by variable switching frequency control. The output voltage of the DC-DC converter is boosted from the input voltage by stacking multiple output stages which enables the sum rectified output voltage of all stages to be higher than the input voltage. In one or more embodiments, the converter can be operated with a variable frequency control. In addition, the power flow can be reversed by changing the polarity of the phase shift between input and output stages.

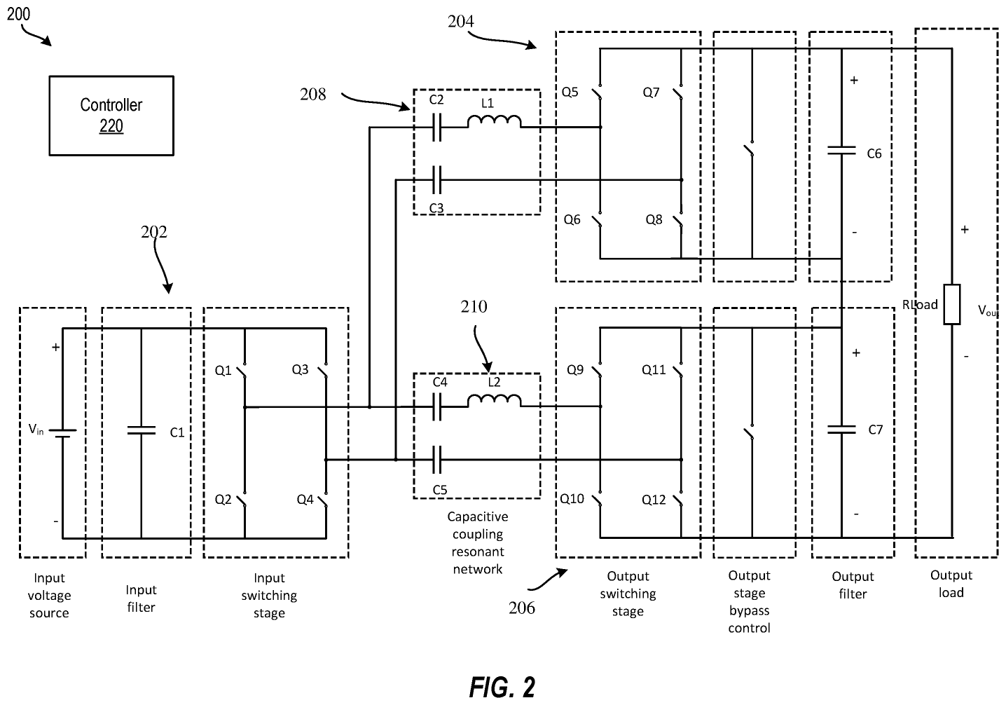

FIG. 2 depicts a block diagram of a circuit topology for a stacked capacitive coupled resonant dual active bridge DC-DC converter according to one or more embodiments. The circuit topology 200 includes an input stage full-bridge power inverter 202 (sometimes referred to as a “power inverter”) that receives the input voltage source Vin and includes an input filter C1 and an input switching stage (i.e., Q1, Q2, Q3, Q4). The input stage full-bridge inverter 202 is in an H-bridge configuration. The input filer C1 is a capacitor and, when a DC voltage from Yin is applied, acts as an energy buffer and filter on the input voltage. In some embodiments, the voltage source Vin can be a DC voltage source coming from one or more batteries and/or a photovoltaic voltage source. The circuit topology 100 also features two output stage full-bridge converters which are referred to as the first output stage full-bridge converter 204 and the second output stage full-bridge converter 206. In one or more embodiments, any number of output stage converters can be utilized based on voltage needs of the load RLoad. The first output stage full-bridge converter 204 is coupled to an output of the input stage full-bridge inverter 202 through a first resonant coupled circuit 208. The second output stage full-bridge converter 206 is coupled to the output of the input stage full-bridge inverter 202 through a second resonant coupled circuit 210. The first resonant coupled circuit 208 includes capacitors C2, C3 and inductor L1 and the second resonant coupled circuit 210 includes capacitors C4, C5 and inductor L2. As mentioned above, the passive coupling circuits 208, 210 allow for a resonant capacitive coupling between the input stage 202 and the output stages 204, 206 of the overall DC-DC converter (i.e., circuit topology 200). In one or more embodiments, the characteristics of the components of the first resonant coupled circuit 208 and the second resonant coupled circuit 210 can be utilized to calculate a resonant frequency. Based on this resonant frequency, the input stage full-bridge inverter 202 can be operated to output a square wave waveform at the calculated resonant frequency. Resonant operation has a higher input to output voltage transformation ratio compared to non-resonant mode. The value of the coupling capacitance is reduced by operating at or above resonant frequency. The input stage full-bridge inverter 202 outputs a square wave at or above the resonant frequency through operation of the switches Q1, Q2, Q3, Q4. In some embodiments, switches Q1 and Q2 are complementary switches meaning when one switch is open, the other is closed. Switches Q3 and Q4 are similarly complementary. In one or more embodiments, the switches Q1, Q2, Q3, Q4 can be controller by controller 220. In one or more embodiments, the switches Q5-Q12 can be implemented using passive diodes and are uncontrolled. In addition, the switches for the first output stage full bridge converter 204 and the second output stage fill-bridge converter 206 can be controller by the controller 220 as well. In one or more embodiments, capacitor C6 acts as an energy buffer and filter to improve the quality of the output voltage. Likewise, capacitor C7 acts as an energy buffer and filter to improve the quality of the output voltage.

In one or more embodiments, the switches Q1-Q12 can be any type of switch including, but not limited to, a metal oxide semiconductor field effect transistor (MOSFET). In one or more embodiments, the switches Q5-Q12 can be any type of switch, but not limited to, passive unidirectional fast switching diodes. The switching frequency of the input and output stage switches is dependent on the resonant frequency of the capacitively coupled resonant network. The resonant frequency for the simplest implementation with LC network is determined as 1/(2π sqrt(LC)). For other embodiments the resonant frequency can be different relation between the various components of the coupling network. For an embodiment with LC network, resonant operation will produce sinusoidal currents in the inductor (L) and sinusoidal voltages in the capacitor (C). When operated at resonance, the current and voltages through switches Q1-Q12 are sequenced such that switches can turn on and turn off without any power loss incurred in the switching operation. When operated at resonance, the power output of the converter can be modulated by delaying or advancing the switching pattern of the devices in each output stage with reference to the switching pattern of the devices in the input stage. By delaying the switching pattern of the output stage with respect to the input stage which is termed as lagging phase shift the power flow direction is from the input to the output stage. By advancing the switching pattern of the output stage with respect to the input stage which is termed as leading phase shift the power flow direction is reversed from the output stage to input stage. In one or more embodiments, the switching pattern of each output stage can be independently adjusted so that some of the stages are leading phase shift and some are lagging phase shift.

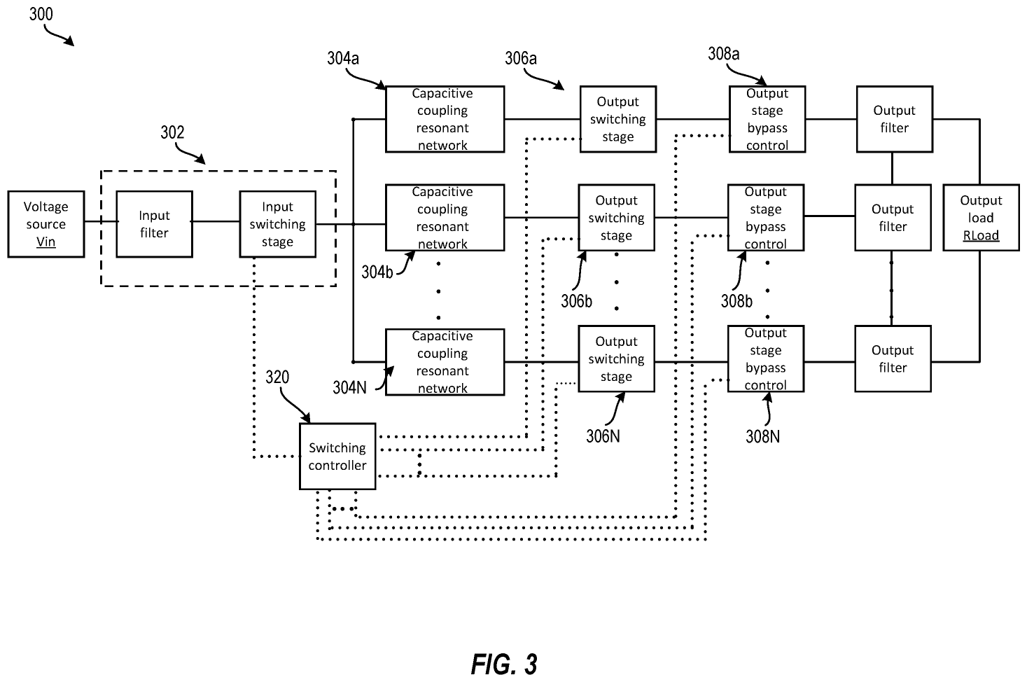

In FIG. 2, the circuit topology 200 includes two output stage full-bridge converters 204, 206, However, any number of output stage converters can be utilized and additionally coupled to the output of the input stage full-bridge inverter 202 by similarly configured resonant coupled circuits. The voltage boost from Vin to the RLoad voltage comes from the stacking of these multiple output stage converters. FIG. 3 depicts a simplified circuit topology 300 for a stacked capacitive resonant dual active bridge DC-DC converter according to one or more embodiments. The circuit topology 300 includes a voltage source Vin, an input stage 302 including an input filter and input switching stage, a switching control 320, a plurality of capacitive coupling resonant network circuits 304a, 304b . . . 304N (where N is any integer greater than 2), a plurality of output switching stages 306a, 306b, . . . , 306N (where N is any integer greater than 2), and a load RLoad. In one or more embodiments, the input stage 302 is similar to the input stage 202 from FIG. 2. Additionally, the output stages 306a, 306b, . . . 306N are similar to the output stage converters 204, 206 from FIG. 2. As shown in the illustrated example, the number of output stages are utilized to boost the input voltage Vin based on the requirements of the load RLoad. Each output stage can optionally include output stage bypass controls 308a, 308b, . . . 308N (where N is any integer greater than 2) so that one or more output stages can be bypassed and turned off without affecting other output stages. Output filters can be included to act as energy buffers and filters to improve the quality of the output voltage. This is done by opening the switch when an output stage (for example, 306N) is not needed based on the voltage boost needs. This allows a circuit topology 300 to be created in a generic sense and allows for the change in voltage boost by operating on the switching control 320. For example for a 200 V input voltage, a 500 V output voltage for the load may be needed. Based on this output voltage need, an appropriate number of output stages can be switched “on” so that the correct voltage is supplied. If a higher (or lower) voltage is needed, the switching control 320 can activate (or deactivate) one or more output stages 306a, 306b, . . . 306N. For example, for a converter operating at full power with N stages, for operating at half power or quarter power a number of output stages can be turned off improving the efficiency at low load.

In one or more embodiments, the controller 220 (in FIG. 2) and switching controller 320 (in FIG. 3) can be implemented by executable instructions and/or circuitry such as a processing circuit and memory. The processing circuit can be embodied in any type of central processing unit (CPU), including a microprocessor, a digital signal processor (DSP), a microcontroller, an application specific integrated circuit (ASIC), a field programmable gate array (FPGA), or the like. Also, in embodiments, the memory may include random access memory (RAM), read only memory (ROM), or other electronic, optical, magnetic, or any other computer readable medium onto which is stored data and algorithms as executable instructions in a non-transitory form.

The capacitive coupling resonant network can be implemented with LC resonant network as shown in this embodiment or with other resonant network configurations,

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system comprising:
a first phase circuit topology comprising:
a power source;
a power inverter circuit;
a plurality of LC circuits comprising a first LC circuit and a second LC circuit; and
a second phase circuit topology comprising:
a plurality of AC-DC converter circuits comprising a first AC-DC converter circuit and a second AC-DC converter circuit, wherein the first AC-DC converter circuit is in a parallel configuration with the second AC-DC converter circuit;
wherein the first LC circuit couples the first phase circuit topology to the first AC-DC converter; and
wherein the second LC circuit couples the first phase circuit topology to the second AC-DC converter.

2. The system of claim 1, wherein the plurality of AC-DC converter circuits further comprises:
a third AC-DC converter circuit, wherein the third AC-DC converter circuit is in a parallel configuration with the first AC-DC converter and second AC-DC converter.

3. The system of claim 2, wherein the plurality of LC circuits further comprises a third LC circuit; and
wherein the third LC circuit couples the first phase circuit topology to the third AC-DC converter.

4. The system of claim 1, wherein the first LC circuit comprises a capacitor in series with an inductor.

5. The system of claim 1, wherein the first LC circuit operates at a resonant frequency with an output of the power inverter circuit.

6. The system of claim 1, wherein the second phase circuit topology further comprises:
a plurality of output capacitors comprising a first output capacitor and a second output capacitor.

7. The system of claim 6, wherein the first output capacitor is in parallel with an output of the first AC-DC converter circuit.

8. The system of claim 1, wherein the power source comprises at least one of a battery and a photovoltaic power source.

9. The system of claim 1, wherein the power inverter circuit comprises an active full-bridge DC-AC converter.

10. The system of claim 3, wherein the active full-bridge DC-AC converter comprises an H bridge configuration.

11. A system comprising:
a first phase circuit topology comprising:
a power source;
a power inverter circuit;
a plurality of LC circuits comprising a first LC circuit and a second LC circuit;
a plurality of switches comprising a first switch and a second switch; and
a second phase circuit topology comprising:
a plurality of AC-DC converter circuits comprising a first AC-DC converter circuit and a second AC-DC converter circuit, wherein the first AC-DC converter circuit is in a parallel configuration with the second AC-DC converter circuit;
wherein the first switch couples the first phase circuit topology to the first LC circuit;
wherein the first LC circuit couples the first switch to the first AC-DC converter;
wherein the second switch couples the first phase circuit topology to the second LC circuit;
wherein the second LC circuit couples the second switch to the second AC-DC converter; and
a controller configured to:
operate the first switch to control the first AC-DC converter circuit; and
operate the second switch to control the second AC-DC converter circuit.

12. The system of claim 11, wherein the plurality of AC-DC converter circuits further comprises:
a third AC-DC converter circuit, wherein the third AC-DC converter circuit is in a parallel configuration with the first AC-DC converter and second AC-DC converter.

13. The system of claim 12, wherein the plurality of LC circuits further comprises a third LC circuit;
wherein the plurality of switches further comprises a third switch;
wherein the third switch couples the first phase circuit topology to the third LC circuit; and
wherein the third LC circuit couples the second switch to the third AC-DC converter.

14. The system of claim 11, wherein the first LC circuit comprises a capacitor in series with an inductor.

15. The system of claim 11, wherein the first LC circuit operates at a resonant frequency with an output of the power inverter circuit.

16. The system of claim 11, wherein the second phase circuit topology further comprises:
a plurality of output capacitors comprising a first output capacitor and a second output capacitor.

17. The system of claim 16, wherein the first output capacitor is in parallel with an output of the first AC-DC converter circuit.

18. The system of claim 11, wherein the power source comprises at least one of a battery and a photovoltaic power source.

19. The system of claim 11, wherein the power inverter circuit comprises an active full-bridge DC-AC converter.

20. The system of claim 13, wherein the active full-bridge DC-AC converter comprises an H bridge configuration.
